(19) United States
(12) Patent Application Publication
(10) Pub. No.: US 2014/0336296 A1
(43) Pub. Date: Nov. 13, 2014

(54) MULTI-FUNCTIONAL BIO POLYURETHANE FOAM AND METHOD FOR MANUFACTURING THE SAME

(71) Applicants: Hyundai Dymos Incorporated, Seonsan (KR); Hyundai Motor Company, Seoul (KR)

(72) Inventors: Seok-Hwan Kim, Gunpo (KR); Jeong-Seok Oh, Yongin (KR); Jun-Ho Song, Seoul (KR); Hyung-Won Jeon, Daejeon (KR)

(73) Assignees: HYUNDAI DYMOS INCORPORATED, Seonsan, Chungnam (KR); HYUNDAI MOTOR COMPANY, Seoul (KR)

(21) Appl. No.: 14/142,879

(22) Filed: Dec. 29, 2013

(30) Foreign Application Priority Data
May 13, 2013 (KR) 10-2013-0053663

(51) Int. Cl. C08G 18/32

(52) U.S. Cl. CPC C08G 18/3203
USPC 521/172; 521/170; 521/174

(57) ABSTRACT

Disclosed is a multi-functional bio polyurethane foam and a method for manufacturing the same. More particularly, disclosed is a multi-functional bio polyurethane foam containing a reaction product of a resin premix and a pre-polymer, in which the resin premix includes from about 5% by weight to about 30% by weight of a biopolyol. The multi-functional bio polyurethane foam has a maximized content of a biopolyol while exhibiting physical properties which are equivalent to those of a petroleum-based polyol-based polyurethane foam in the related art, and further provides a strengthened antibacterial function and minimized vibration transmissivity.

### CROSS-REFERENCE TO RELATED APPLICATIONS

This application claims priority under 35 U.S.C. §119 to Korean Patent Application No. 10-2013-0053663, filed on May 13, 2013, in the Korean Intellectual Property Office, the disclosure of which is incorporated herein by reference in its entirety.

### BACKGROUND OF THE INVENTION

1. Field of the Invention

The present invention relates to a polyurethane foam, and more particularly, to a multi-functional bio polyurethane foam having a maximized content of a biopolyol which is applied to an automobile seat and the like, and a method for manufacturing the same. The polyurethane foam exhibits physical properties which are equivalent to those of a petroleum-based polyol-based polyurethane foam in the related art, and has a strengthened antibacterial function and minimized vibration transmissivity.

2. Description of the Related Art

As international crude oil prices continue to increase, the crisis of the petrochemical industry depending on petroleum resources continues. Further, regulations on emission of greenhouse gases are continually strengthened due to global warming resulting from the consumption of petroleum resources. As such, studies in biotechnology have been actively conducted with the goal of reducing dependency on petroleum resources.

Here, biotechnology means a technology that uses biomass repeatedly produced through photosynthesis of plants in a natural system as a raw material. This is in contrast with the existing chemical industry-based technology which depends on petroleum resources which are a fossil raw material. Such biotechnology may be a new type of bio-chemistry fusion technology which enables the human race to sustainably grow and survive by replacing a part or a substantial part of the existing chemical industry.

When the greenhouse gas emission of products using petro chemical materials is compared with that of products using bio materials in terms of environmental contamination, the greenhouse gas emissions of the petro chemical material-based products are greater than those of bio material-based products. In particular, the petro chemical material-based products are subjected to processes of performing a petrochemical purification, transferring the purified raw materials, producing a product, transferring the produced product, and then disposing of the product. In the petrochemical purification, product production and product disposal processes, a significant amount of greenhouse gases are emitted. In contrast, a bio material-based product is subjected to processes of growing plants, transferring plant-based raw materials, producing a product, biodegrading the product, and disposing of the product. When plants are grown, greenhouse gases are absorbed, and less greenhouse gas is emitted (i.e. less than the greenhouse gas emission from petro chemical materials) when the product is produced and disposed of. Thus, the importance of the biomaterial-related technology is increasing because it can provide an effective response to the carbon tax system due to reduction in carbon dioxide, improve competitiveness of the product, and reduce costs due to the increase in costs of petroleum resources.

This bio material-based technology is steadily developing under the change of the 21st century type chemical industry paradigm seeking an environmentally friendly and sustainable growth raw material. In particular, the trend of the chemical material industry as it relates to polymers is focused on development and production of bio-plastics using biomass as a raw material, thereby providing lower prices and environmental protection.

In particular, as various countries seek to secure plant-based raw materials, various vegetable oil-based biopolyols have been developed and are commercially available. For example, the US, Malaysia, and Europe have developed various biopolyols based on soybean oil, palm oil, and castor oil or sunflower oil, respectively.

However, a polyol, which is applied to a polyurethane foam for an automobile seat, and the like, is required to have a high molecular weight. However, most of the vegetable oil-based biopolyols are industrially used and, thus, have smaller molecular weights than those of petroleum-based biopolyols in the related art. Further, most of the vegetable oil-based biopolyols contain unreacted materials which can cause a collapse or determination of physical properties of a foam formed therefrom.

When a chemical process of removing the unreacted materials in such biopolyols is performed, there is a problem in that depending on the process, production costs are increased, and an advantage of reduction in greenhouse gas emission by using bio materials disappears or diminishes.

Meanwhile, since the amount of time a driver stays in an automobile has increased with the recent development of the automobile industry, the importance of a comfortable ride is increasingly important. However, an automobile seat which is directly in contact with the driver and, thus, closely related to how comfortable the ride feels, has a problem in that comfort deteriorates due to high vibration transmissivity of a polyurethane foam which is typically applied to an automobile seat in the related art and the like.

### SUMMARY OF THE INVENTION

The present invention provides a multi-functional bio polyurethane foam and a method for manufacturing the same. In particular, the multi-functional bio polyurethane foam of the present invention exhibits excellent comfort due to minimized vibration transmissivity, while also exhibiting shape and physical properties equivalent to those of a polyurethane foam manufactured by a polymerization reaction using a petroleum-based polyol in the related art. The multi-functional bio polyurethane foam of the present invention is more environmentally friendly and has a strengthened antibacterial effect as compared with conventional polyurethane foams.

According to various embodiments, the multi-functional bio polyurethane foam maximizes the content of the biopolyol, thereby providing numerous advantages such as an increase in environmental friendliness and strengthened antibacterial effect.

According to an exemplary embodiment, the multi-functional bio polyurethane foam of the present invention is a polyurethane foam containing a reaction product of a resin premix and a pre-polymer. In particular, the resin premix preferably includes from about 5% by weight to about 30% by weight of a biopolyol. According to embodiments of the invention, a “maximized content of the biopolyol” refers to about 5% by weight to about 30% by weight of a biopolyol in the resin premix.

According to a preferred embodiment, the pre-polymer is present in an amount from about 30 parts by weight to about 70 parts by weight based on 100 parts by weight of the resin premix. Preferably, the pre-polymer is formed by a pre-polymerization reaction of isocyanate and the biopolyol. The biopolyol can be prepared from plant-based raw materials or various vegetable oil-based biopolyols. Preferably, the biopolyol is prepared from castor oil or soybean oil. According to an embodiment, the isocyanate includes from about 10% by weight to about 70% by weight of monomeric methylene diphenyl diisocyanate (MMDI), from about 10% by weight to about 70% by weight of carbodiimide modified methylene diphenyl diisocyanate, from about 10% by weight to about 90% by weight of polymeric methylene diphenyl diisocyanate (PMDI), and from about 5% by weight to about 80% by weight of toluene diisocyanate (TDI) based on the total weight of the isocyanate.

Meanwhile, considering the reaction efficiency and the like, it is preferred that % by weight of the biopolyol included in the resin premix based on the weight of the resin premix is the same or about the same as % by weight of the biopolyol which is pre-polymerized with the isocyanate based on the weight of the pre-polymer.

As an exemplary embodiment of the present invention, the resin premix may further include from about 5% by weight to about 40% by weight of a base polyol, from about 15% by weight to about 55% by weight of a high molecular weight polyol, and from about 3% by weight to about 40% by weight of a polymer polyol. According to preferred embodiments, the biopolyol has a molecular weight (MW) from about 2,500 to about 3,500, the base polyol has a molecular weight (MW) from about 5,000 to about 6,000, and the high molecular weight polyol has a molecular weight (MW) from about 6,500 to about 7,500. According to various embodiments, the base polyol and the high molecular weight polyol are selected from any such polyols having the above molecular weights, and, for example, may be selected from a polyether polyol, a polyester polyol, or a combination thereof.

As an exemplary embodiment of the present invention, the resin premix may further include from about 0.1% by weight to about 1% by weight of a chain extender, more than 0 and less than about 5% by weight of a cross-linker, and from about 0.1% by weight to about 3% by weight of a silicone surfactant. The chain extender and cross-linker can be selected from any known chain extenders and cross-linkers. According to various embodiments, the silicone surfactant includes a first silicone surfactant and a second silicone surfactant which is relatively more active than the first silicone surfactant. Any conventional silicone surfactants can be suitably used.

As an exemplary embodiment of the present invention, the resin premix further includes from about 1% by weight to about 5% by weight of a foaming agent, from about 0.1% by weight to 3 about % by weight of a gelling catalyst, and from about 0.1% by weight to about 3% by weight of a blowing catalyst. Any conventional foaming agents, gelling catalysts and blowing catalysts can suitably be used.

According to another aspect, the present invention provides an automobile seat manufactured of the multi-functional bio polyurethane foam described above.

According to another aspect, the present invention provides a method for manufacturing a multi-functional bio polyurethane foam including: forming a pre-polymer by pre-polymerizing a biopolyol with isocyanate; and manufacturing a polyurethane foam by reacting the pre-polymer with a resin premix including from about 5% by weight to about 30% by weight of the biopolyol.

At this time, the isocyanate may include from about 10% by weight to about 70% by weight of monomeric methylene diphenyl diisocyanate (MMDI), from about 10% by weight to about 70% by weight of carbodiimide modified methylene diphenyl diisocyanate, from about 10% by weight to about 90% by weight of polymeric methylene diphenyl diisocyanate (PMDI), and from about 5% by weight to about 80% by weight of toluene diisocyanate (TDI) based on the total weight of the isocyanate. In view of the reaction efficiency and the like, it is preferred that % by weight of the biopolyol included in the resin premix based on the weight of the resin premix is the same as or about the same as % by weight of the biopolyol which is pre-polymerized with the isocyanate based on the weight of the pre-polymer.

The polyurethane foam according to the exemplary embodiments of the present invention having the aforementioned configuration exhibits shape and physical properties which are equivalent to those of a petroleum-based polyol-based polyurethane foam by improving the drawbacks of a biopolyol-based polyurethane foam in the related art.

The polyurethane foam is advantageous in that excellent antibacterial properties are exhibited. For example, the number of Staphylococcus aureus, Klebsiella pneumoniae, or the like are decreased by unreacted materials contained in the biopolyol.

According to embodiments of the present invention, the content of the biopolyol may be maximized by introducing a pre-polymerization reaction, thereby producing an environmentally friendly product which may significantly reduce the greenhouse gas emission.

Meanwhile, when the polyurethane foam according to the present invention is applied to an automobile seat and the like, there is an effect of improving comfort by maximally absorbing vibration generated during driving.

Other aspects and exemplary embodiments of the invention are discussed infra.

### BRIEF DESCRIPTION OF THE DRAWINGS

The above and other features and advantages of the present invention will become more apparent by describing in detail exemplary embodiments thereof with reference to the attached drawings in which:

FIG. 1 is a photograph illustrating a biopolyol-based polyurethane foam in the related art, which includes 10% by weight of a biopolyol based on the weight of a resin premix.

FIG. 2 is a photograph illustrating a biopolyol-based polyurethane foam in the related art, which includes 20% by weight of a biopolyol based on the weight of a resin premix.

FIG. 3 is a photograph illustrating a biopolyol-based polyurethane foam in the related art, which includes 30% by weight of a biopolyol based on the weight of a resin premix.

FIG. 4 is a schematic view in which the bio polyurethane foam in the related art is manufactured.

FIG. 5 is a schematic view in which a bio polyurethane foam is manufactured by a pre-polymerization reaction according to an embodiment of the present invention.

FIG. 6 is a specific process view for forming a pre-polymer according to an embodiment of the present invention.

FIG. 7 is a view in which vibration transmissivity is measured by a vibration transmission measuring device according to an exemplary embodiment of the present invention.

FIG. 8 is a graph showing the results of vibration transmissivity measurements in Comparative Example 1 and Examples 1 and 4.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Terms or words used in the present specification and claims should not be interpreted as being limited to typical or dictionary meanings, but should be interpreted as meanings and concepts which comply with the technical spirit of the present invention, based on the principle that an inventor can appropriately define a concept of a term to describe his/her own invention in the best manner. Therefore, configurations illustrated in the embodiments and the drawings described in the present specification are only the most preferred embodiment of the present invention and do not represent all of the technical spirit of the present invention, and thus it is to be understood that various modified examples, which may replace the configurations, are possible when filing the present application. Hereinafter, the present invention will be described in detail with reference to the accompanying drawings, in which exemplary embodiments of the invention are shown. As those skilled in the art would realize, the described embodiments may be modified in various different ways, all without departing from the spirit or scope of the present invention.

The unrelated parts to the description of the exemplary embodiments are not shown to make the description clear and like reference numerals designate like element throughout the specification.

Further, the sizes and thicknesses of the configurations shown in the drawings are provided selectively for the convenience of description, so that the present invention is not limited to those shown in the drawings and the thicknesses are exaggerated to make some parts and regions clear.

Throughout the specification, unless explicitly described to the contrary, the word “comprise” and variations such as “comprises” or “comprising” will be understood to imply the inclusion of stated elements but not the exclusion of any other elements.

Further, the terms, “ . . . unit”, “ . . . mechanism”, “ . . . portion”, “ . . . member” etc. used herein mean the unit of inclusive components performing at least one or more functions or operations.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In one aspect, the present invention relates to a multi-functional bio polyurethane foam, which is more environmentally friendly and has a strengthened antibacterial function by maximizing the content of a biopolyol, and has excellent vibration absorption capacity through optimization of the molecular weight of polyol and isocyanate components.

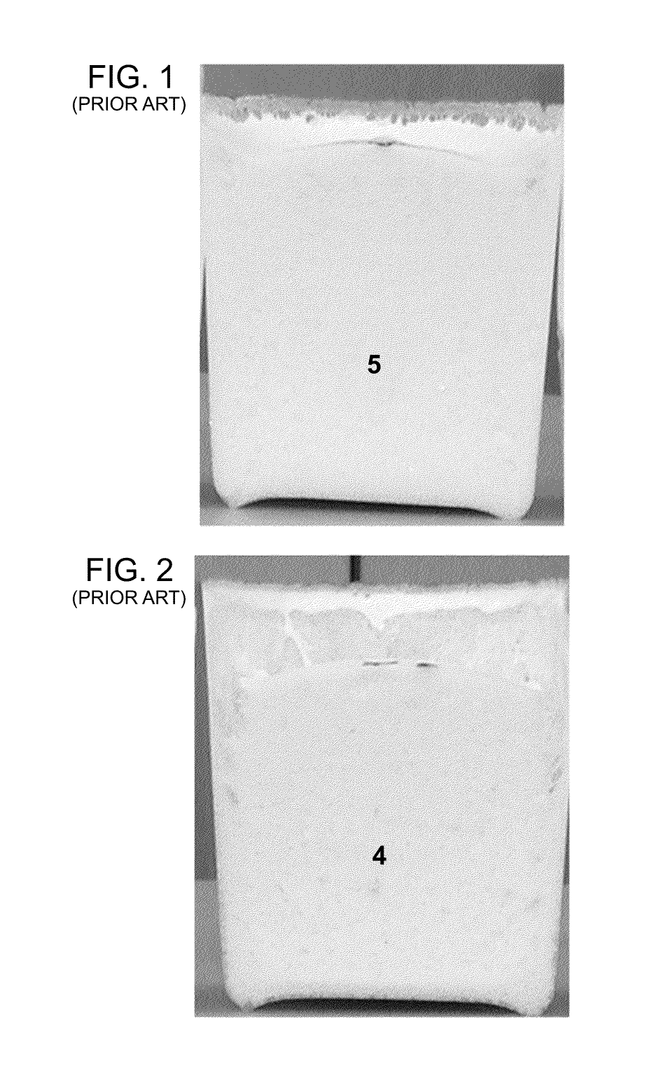

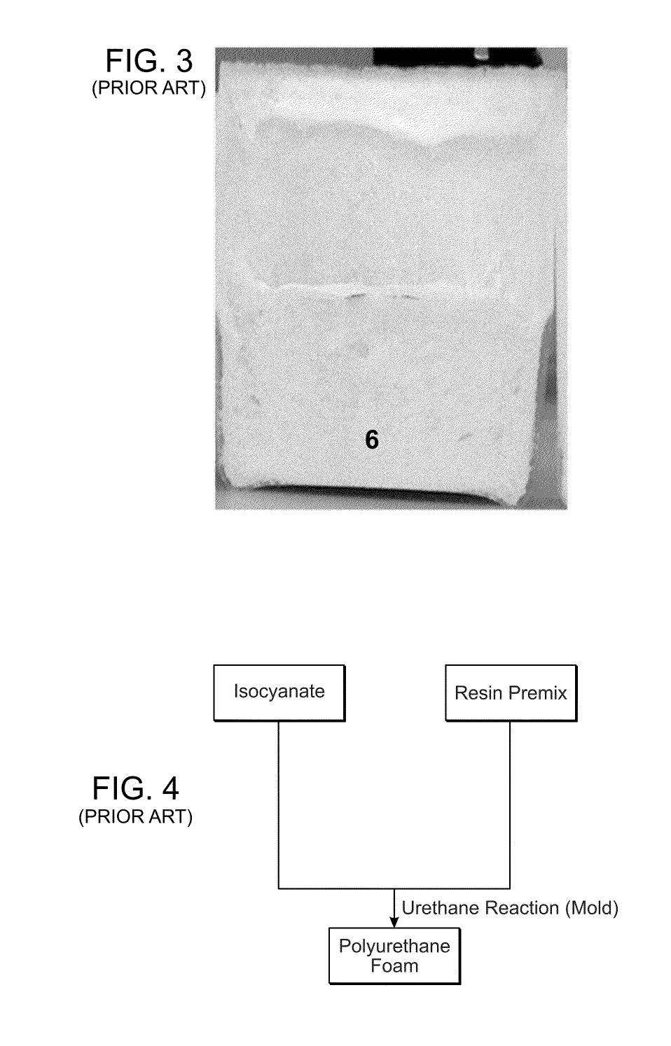

FIGS. 1 to 3 are photographs illustrating biopolyol-based polyurethane trams in the related art, which include 10% by weight, 20% by weight, and 30% by weight, respectively, of a biopolyol based on the weight of a resin premix. As illustrated in FIGS. 1 to 3, as the content of a biopolyol in the castor oil- or soybean oil-based bio polyurethane foam in the related art is increased, the amount of unreacted materials contained in the biopolyol is also increased. This increase in unreacted materials results in an increase in the severity of collapsing of the foam and deterioration in physical properties thereof.

As an example, castor oil-based biopolyols include ricinoleic acid as a main component and further include stearic acid, linoleic acid, oleic acid, and the like. Components other than the ricinoleic acid are present as unreacted materials and block foam from being formed normally. Likewise, unreacted materials in soybean oil-based biopolyols also result in determination of physical properties of a foam formed therefrom.

The antibacterial bio polyurethane foam of the present invention solves these problems and provides a multi-functional bio polyurethane foam which has shape and physical properties equivalent to those of a petroleum-based polyol-based polyurethane foam in the related art. In particular, the antibacterial bio polyurethane foam of the present invention does so by containing a reaction product of a resin premix and a pre-polymer, wherein the resin premix includes a biopolyol with a maximized content, other polyols, various additives, and the like. As such, an antibacterial effect is strengthened through the unreacted materials, and excellent vibration absorption capacity is provided by optimizing a molecular weight of the polyol and controlling the composition of the isocyanate.

In particular, the present invention provides a polyurethane foam containing a reaction product of a resin premix and a pre-polymer, in which the resin premix includes from about 5% by weight to about 30% by weight of a bio polyol based on the weight of the resin premix.

The pre-polymer is preferably formed by a pre-polymerization reaction of the isocyanate and the biopolyol.

According to embodiments of the invention, the pre-polymer is preferably present in an amount of from about 30 parts by weight to about 70 parts by weight, and more preferably about 50 parts by weight based on 100 parts by weight of the resin premix. When the content of the pre-polymer is less than 30 parts by weight, cell stability of the foamed body deteriorates, and when the content thereof exceeds 70 parts by weight, there is a risk that the molded foam crumbles due to excessive formation of foam cells. As such, it is preferred that the noted range is satisfied.

### (A) Biopolyol

As used herein, the biopolyol means a polyol prepared using vegetable oil extracted from seeds or fruits of various plants, animal oil which uses various fish-based oil as a raw material, or the like. This is in contrast with polyether polyol or polyester polyol, which is produced from petroleum chemical materials. According to preferred embodiments, the molecular weight of the biopolyol in the present invention is from about 2,500 to about 3,500 in consideration of vibration transmissivity.

According to various embodiments, the biopolyol according to the present invention is prepared by a typically known method from vegetable oil which exhibits environmentally friendly effects. Preferably, the vegetable oil is one or more selected from the group consisting of castor oil, soybean oil, palm oil, canola oil, sunflower oil, and the like. According to particularly preferred embodiments, castor oil or soybean oil, which exhibit antibacterial effects as can be confirmed through the following Examples, are used.

According to various embodiments, it is preferred that the biopolyol is included in an amount from about 5% by weight to about 30% by weight based on the weight of the resin premix. When the content of the biopolyol is less than 5% by weight, effects of adding the biopolyol, that is, reduction in greenhouse gas emission and the antibacterial effect are minimal. On the other hand, when the content of the biopolyol exceeds 30% by weight, it is difficult to form a foam and physical properties deteriorate. As such, it is preferred that the range is satisfied.

Meanwhile, in order to secure the reaction stability and increase the reaction efficiency, it is preferred that % by weight of the biopolyol included in the resin premix based on the weight of the resin premix is the same as or about the same % by weight of the biopolyol which is pre-polymerized with the isocyanate based on the weight of the pre-polymer.

### (B) Isocyanate

In general, the isocyanate used in the manufacture of the polyurethane foam includes methylene diphenyl diisocyanate (MDI), toluene diisocyanate (TDI), or a combination thereof. In particular, in order to improve vibration absorption capacity, it is preferred that the isocyanate of the present invention has the composition of the following Table 1.

TABLE 1

| Constituent element | Composition |
|---|---|
| Monomeric methylene diphenyl | about 10% by weight to about 70% |
| diisocyanate (MMDI) | by weight |
| Carbodiimide modified MDI | about 10% by weight to about 70% |
| | by weight |
| Polymeric methylene diphenyl | about 10% by weight to about 90% |
| diisocyanate (PMDI) | by weight |
| Toluene diisocyanate (TDI) | about 5% by weight to about 80% |
| | by weight |

As described in Table 1, the isocyanate according to the present invention preferably includes from about 10% by weight to about 70% by weight of monomeric methylene diphenyl diisocyanate (MMDI), from about 10% by weight to about 70% by weight of carbodiimide modified methylene diphenyl diisocyanate, from about 10% by weight to about 90% by weight of polymeric methylene diphenyl diisocyanate and from about 5% by weight to about 80% by weight of toluene diisocyanate (TDI) based on the total weight of the isocyanate.

Here, it is preferred that the monomeric methylene diphenyl diisocyanate (MMDI) and the carbodiimide modified methylene diphenyl diisocyanate are included in an amount from about 10% by weight to about 70% by weight, respectively. When the content of MMDI is less than 10% by weight based on the total weight of the isocyanate, closed cells are excessively generated and productivity is reduced. On the other hand, when the content of MMDI exceeds 70% by weight, opened cells are excessively generated and the foam is not produced, thereby increasing the defective ratio. As such, it is preferred that the range is satisfied.

It is preferred that the polymeric methylene diphenyl diisocyanate (PMDI) is included in an amount from about 10% by weight to about 90% by weight. When the content of PMDI is less than 10% by weight based on the total weight of the isocyanate, tensile and tear strengths are rapidly reduced. On the other hand, when the content of PMDI exceeds 90% by weight, the hardness thereof rapidly is increased. As such, it is preferred that the range is satisfied.

It is preferred that the toluene diisocyanate (TDI) is included in an amount from about 5% by weight to about 80% by weight. When the content of TDI is less than 5% by weight based on the total weight of the isocyanate, the rebound resilience is reduced. On the other hand, when the content of TDI exceeds 80% by weight, vibration transmissivity is increased and hardness is reduced. As such, it is preferred that the range is satisfied.

According to embodiments of the invention, it is preferred that the resin premix further includes from about 5% by weight to about 40% by weight of a base polyol, from about 15% by weight to about 55% by weight of a high molecular weight polyol, and from about 3% by weight to about 40% by weight of a polymer polyol.

### (C) Base Polyol

As referred to herein, the base polyol means any petroleum-based polyol in the related art, and is a commonly known polyol which is applied to a polyurethane foam such as, for example, polyether polyol, polyester polyol, or a combination thereof. Preferably, the base polyol has a molecular weight (MW) of from about 5,000 to about 6,000 in consideration of the vibration transmissivity.

It is preferred that the base polyol is included in an amount from about 5% by weight to about 40% by weight based on the weight of the resin premix. When the content of the base polyol is less than 5% by weight, the base polyol is disadvantageous in high vibration transmissivity. On the other hand, when the content of the base polyol exceeds 40% by weight, the ratio of permanent shrinkage by compression is reduced. As such, it is preferred that the range is satisfied.

### (D) High Molecular Weight Polyol

As referred to herein, the high molecular weight polyol means a commonly known polyol which is applied to a polyurethane foam, such as polyether polyol, polyester polyol or a combination thereof. Preferably, the molecular weight (MW) of the high molecular weight polyol is larger than that of the base polyol in order to improve rebound resilience and elongation of the foam formed. Preferably, the molecular weight (MW) of the high molecular weight polyol is from about 6,500 to about 7,500.

It is preferred that the high molecular weight polyol is included in an amount from about 15% by weight to about 55% by weight based on the weight of the resin premix. When the content of the high molecular weight polyol is less than 15% by weight, the rebound resilience ratio is significantly reduced. On the other hand, when the content of the high molecular weight polyol exceeds 55% by weight, the rebound resilience ratio is increased and comfort required from a soft polyurethane foam deteriorates. As such, it is preferred that the range is satisfied.

### (E) Polymer Polyol

The polymer polyol is also referred to as a copolymer polyol, and it is mixed with a base polyol so as to improve the hardness and the like.

It is preferred that the polymer polyol is included in an amount from about 3% by weight to about 40% by weight based on the weight of the resin premix. When the content of the polymer polyol is less than 3% by weight, the hardness is significantly reduced and the polyurethane foam has a narrow range of potential applications. On the other hand, when the content of the polymer polyol exceeds 40% by weight, hardness and vibration transmissivity are increased and comfort deteriorates. As such, it is preferred that the range is satisfied.

Meanwhile, it is preferred that the resin premix further includes from about 0. by weight to about 1% by weight of a chain extender, more than 0 and less than about 5% by weight of a cross-linker, and from about 0.1% by weight to about 3% by weight of a silicone surfactant.

### (F) Chain Extender and Cross-Linker

The chain extender and the cross-linker are reactive single molecules used to strengthen intermolecular bonds. In particular, the chain extender serves to extend the main chain, and divalent alcohols or amines are usually used as the chain extender. The cross-linker serves to make the chain a network structure or branch structure, and trivalent or greater than trivalent alcohols and amines are usually used as the cross-linker. As such, the chain extender and cross-linker help to prevent the collapse of the foam and improving tensile strength, dry set and the like.

As an exemplary embodiment of the present invention, the chain extender is a 1,4-butane diol (OH—V=from 500 to 1,500 mg KOH/g), and the cross-linker is triethanolamine.

It is preferred that the chain-extender is included in an amount from about 0.1% by weight to about 1% by weight based on the weight of the resin premix. When the content of the chain-extender is less than 0.1% by weight, the effect of extending the main chain is minimal. On the other hand, when the content of the chain-extender exceeds 1% by weight, fluidity deteriorates. As such, it is preferred that the range is satisfied.

It is preferred that is included in an amount more than 0 and less than about 5% by weight based on the weight of the resin premix. When the content of the cross-linker exceeds 5% by weight, fluidity deteriorates and the defective ratio is increased. As such, it is preferred that the range is satisfied.

### (G) Silicone Surfactant

The silicone surfactant serves to facilitate mixing of raw materials (emulsification), help the growth of bubbles by decreasing the surface tension of the urethane system, and prevent gases from being diffused by decreasing the pressure difference among bubbles. According to a preferred embodiment, the silicone surfactant includes the following first silicone surfactant and second silicone surfactant.

TABLE 2

| | First silicone | Second silicone |
|---|---|---|
| | surfactant | surfactant |
| Silicone polymer molecular | Low | High |
| weight (M/W) | | |
| Branched polyether | Low | High |
| Branched polyethylene ethylene oxide | High | Low |
| (PEEO) | | |

Table 1 shows the results of comparing the first silicone surfactant and the second silicone surfactant which are preferably used in the present invention. In particular, the first silicone surfactant can be any silicone surfactant used in the petroleum-based polyol-based polyurethane foam in the related art. According to preferred embodiments of the present invention, the second silicone surfactant is additionally added along with the first silicone surfactant. Preferably, the second silicone surfactant is more active than the first silicone surfactant, and has an effect of more efficiently preventing collapse of the foam caused by addition of the biopolyol.

Preferably, the silicone surfactant including the first silicone surfactant and the second silicone surfactant is included in an amount from about 0.1% by weight to about 3% by weight based on the weight of the resin premix. When the content of the silicone surfactant is less than 0.1% by weight, it is difficult to form the urethane foam. On the other hand, when the content of the silicone surfactant exceeds 3% by weight, productivity is reduced due to excessive generation of closed cells. As such, it is preferred that the range is satisfied.

According to preferred embodiments, the resin premix further includes from about 1% by weight to about 5% by weight of a foaming agent, from about 0.1% by weight to about 3% by weight of a gelling catalyst, and from about 0.1% by weight to about 2% by weight of a blowing catalyst.

### (H) Foaming Agent

The foaming agent is a material used in order to manufacture a foam, and serves to form bubbles during a polymer reaction. Any conventional foaming agents may suitable be used in the present invention.

It is preferred that the foaming agent is included in an amount from about 1% by weight to about 5% by weight based on the weight of the resin premix. When the content of the foaming agent is less than 1% by weight, the foaming ratio becomes low and it is difficult to form a foam. On the other hand, when the content of the foaming agent exceeds 5% by weight, physical properties deteriorate due to excessive foaming. As such, it is preferred that the range is satisfied.

### (1) Gelling Catalyst and Blowing Catalyst

The gelling catalyst is a catalyst which promotes the reaction of polyol and isocyanate. Any known gelling catalysts can be suitably used in the present invention, and, for example, organic metal series (tin compounds, lead compounds and the like), some tertiary amines (TEDA) or the like may be used as the gelling catalyst. The blowing catalyst is a catalyst which promotes a saturation reaction of isocyanate and water. Any known blowing catalysts can be suitably used in the present invention, and, for example, some tertiary amines (PMDETA and BDMEE) and the like may be used as the blowing catalyst.

Preferably, the gelling catalyst is included in an amount from about 0.1% by weight to about 3% by weight based on the weight of the resin premix. When the content of the gelling catalysts is less than 0.1% by weight, curability deteriorates and productivity is reduced. On the other hand, when the content of the gelling catalyst exceeds 3% by weight, fluidity deteriorates and pore defects may be generated. As such, it is preferred that the range is satisfied.

Preferably, the blowing catalyst is included in an amount from about 0.1% by weight to about 2% by weight based on the weight of the resin premix. These upper and lower limits are preferred for the same reasons as those of the gelling catalyst.

The thus provided polyurethane foam has strengthened antibacterial property and excellent vibration absorption capacity by using a bio material, and further exhibits physical properties which are equivalent to those of the petroleum-based polyol-based polyurethane foams in the related art. As such, the present polyurethane foam may be suitably applied to the manufacture of an automobile seat and the like.

In another aspect, the present invention relates to a method for manufacturing a multi-functional bio polyurethane foam, wherein the multi-functional bio polyurethane foam has a maximized content of biopolyols by introduction of a pre-polymerization reaction. As such, the thus formed multi-functional bio polyurethane foam is more environmentally friendly, and has strengthened antibacterial function and minimized vibration transmissivity.

FIG. 4 is a schematic view in which the bio polyurethane foam in the related art is manufactured. As illustrated, the polyurethane foam may be manufactured through a urethane reaction of the resin premix, which includes a biopolyol and the like and isocyanate.

However, when a typical polymerization reaction is used, the biopolyol may only be included in an amount up to 20% by weight based on the weight of the resin premix. When the content thereof exceeds 20% by weight, collapse of the foam and deterioration in physical properties thereof are caused due to unreacted materials added to the biopolyol. Thus, as previously mentioned, the biopolyol may be included only in an amount less than 30% by weight based on the weight of the resin premix.

The present invention maximizes the content of biopolyols by introducing a pre-polymerization reaction which is a new raw material blending technology.

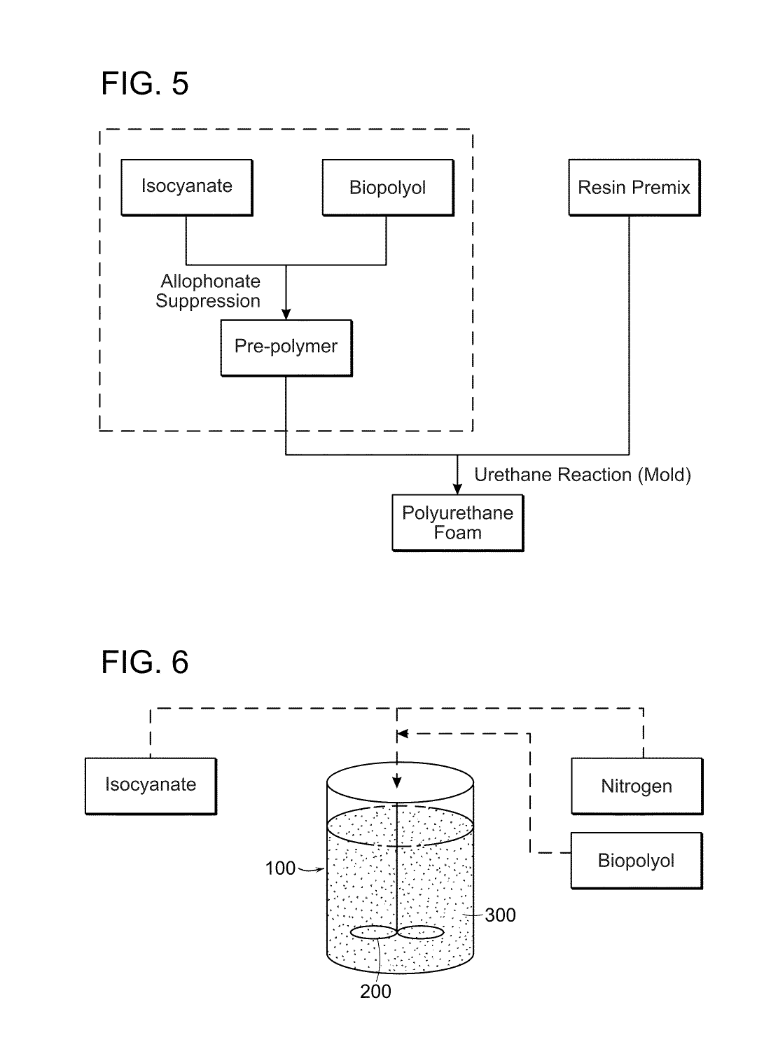

FIG. 5 is a schematic view in which a bio polyurethane foam is manufactured by a pre-polymerization reaction according to an embodiment of the present invention. As illustrated, a pre-polymer is formed by first pre-polymerizing a biopolyol with isocyanate.

FIG. 6 is a specific process view for forming a pre-polymer according to an embodiment of the present invention. As shown, it is preferred to prevent moisture from flowing into a reactor 100 using nitrogen pressure. When the rate of adding the biopolyol into the reactor 100 into which isocyanate has been injected is fast, a high reaction heat is generated due to a rapid urethane reaction. Further, allophonate, in which isocyanate is bonded to urethane, is generated. As such, it is preferred that a pre-polymer 300 is formed by slowly introducing the biopolyol thereinto and stirring the mixture with a stirrer 200 such that the allophonate reaction does not occur. The rate at which biopolyol is considered to be slow is a gradual rate at which allophonate is not formed, which could be readily ascertained by one skilled in the art.

Next, the polyurethane foam according to the present invention is manufactured by reacting the pre-polymer with the resin premix (Urethane reaction). Preferably, the resin premix includes from about 5% by weight to about 30% by weight of the biopolyol.

At this time, the specific composition, conditions and the like of the resin premix and pre-polymer used in the present invention are the same as those previously mentioned above.

Through the pre-polymerization reaction carried out by the present invention, the biopolyol in the resin premix is included in an amount from about 5% by weight to about 30% by weight based on the weight of the resin premix. As such, the content of the biopolyol may be maximized and physical properties, which are equivalent to those of a petroleum-based polyol in the related art, and strengthened antibacterial property may be exhibited without causing collapse of the foam.

### Example

Hereinafter, the present invention will be described in more detail through Examples. These Examples are only for illustrating the present invention, and it will be obvious to those skilled in the art that the scope of the present invention is not interpreted to be limited by these Examples.

TABLE 3

| | Comparative | Comparative | Comparative | | | | |
|---|---|---|---|---|---|---|---|
| | Example 1 | Example 2 | Example 3 | Example 1 | Example 2 | Example 3 | Example 4 |
| | (% by weight) | (% by weight) | (% by weight) | (% by weight) | (% by weight) | (% by weight) | (% by weight) |
| Base polyol | 66.66 | 56.66 | 46.66 | 9.39 | 19.33 | 28.64 | 9.29 |
| (MW 5500) | | | | | | | |
| Biopolyol | — | — | — | 27.89 | 27.89 | 27.89 | 28.89 |
| (MW 3000) | | | | | | | |
| High molecular weight | — | 10.0 | 20.0 | 27.96 | 18.02 | 8.71 | 27.88 |
| polyol (MW 7000) | | | | | | | |
| (Polymer polyol) | 28.57 | 28.57 | 28.57 | 27.96 | 27.96 | 27.96 | 25.88 |
| Blowing catalyst | 0.29 | 0.29 | 0.29 | 0.28 | 0.28 | 0.28 | 0.28 |
| Gelling catalyst | 0.67 | 0.67 | 0.67 | 0.65 | 0.65 | 0.65 | 0.65 |
| Cross-linker | — | — | — | 0.65 | 0.65 | 0.65 | 0.74 |
| Chain extender | — | — | — | 1.40 | 1.40 | 1.40 | 1.58 |
| First silicone surfactant | 0.95 | 0.95 | 0.95 | 0.74 | 0.74 | 0.74 | 0.74 |
| Second silicone | — | — | — | 0.28 | 0.28 | 0.28 | 0.28 |
| surfactant | | | | | | | |
| Foaming agent | 2.86 | 2.86 | 2.86 | 2.80 | 2.80 | 2.80 | 2.79 |

Table 3 shows the results of comparing the compositions of the petroleum-based polyol-based resin premixes (Comparative Examples 1 to 3) in the related art, the biopolyol-based resin premixes (Examples 1 to 3) prepared from castor oil according to the present invention, and the biopolyol-based resin premix (Example 4) prepared from soybean oil according to the present invention. In particular, in the compositions according to the present invention, a polyurethane foam was manufactured by reacting 50 parts by weight of a pre-polymer based on 100 parts by weight of the resin premix having the composition set out in Table 3. Physical properties thereof were measured, and the results are shown in the following Table 4.

TABLE 4

| | Comparative | Comparative | Comparative | | | | |
|---|---|---|---|---|---|---|---|
| | Example 1 | Example 2 | Example 3 | Example 1 | Example 2 | Example 3 | Example 4 |
| Hardness (ILD) | 26.2 | 26.0 | 25.7 | 25.8 | 26.0 | 26.1 | 26.6 |
| Rebound resilience | 65 | 66 | 67 | 60 | 61 | 56 | 60 |
| Tension | 1.7 | 1.7 | 1.7 | 1.6 | 1.6 | 1.6 | 1.5 |
| Elongation | 120 | 123 | 125 | 113 | 118 | 110 | 112 |

As shown in Table 4, it was confirmed that while the polyurethane foam according to the present invention includes up to 30% by weight of the biopolyol based on the weight of the resin premix, it still exhibits a shape and physical properties which are equivalent to those of the petroleum-based polyol-based polyurethane foam in the related art.

It was then confirmed in detail in the following that the polyurethane foam according to the present invention has strengthened antibacterial effect by unreacted materials in the biopolyol.

TABLE 5

| | | | Compar- | | |
|---|---|---|---|---|---|
| | | | ative | Example | Example |
| Classification | | BLANK | Exarnple 1 | 1 | 4 |
| Staphylo- | Initial number | 2.0 × 10⁴ | 2.0 × 10⁴ | 2.0 × 10⁴ | 3.0 × 10⁴ |
| coccus | of bacteria/ml | | | | |
| aureus | 18 hours | 2.2 × 10⁶ | 1.3 × 10⁶ | 8.5 × 10⁴ | 2.9 × 10³ |
| | later/ml | | | | |
| | Reduction ratio | — | 40.9% | 96.1% | 99.9% |
| | of bacteria | | | | |
| Klebsiella | Initial number | 2.5 × 10⁴ | 2.5 × 10⁴ | 2.5 × 10⁴ | 2.0 × 10⁴ |
| pneu- | of bacteria/ml | | | | |
| moniae | 18 hours | 1.6 × 10⁶ | 8.5 × 10⁶ | 5.0 × 10⁴ | <10 |
| | later/ml | | | | |
| | Reduction ratio | — | 46.9% | 68.8% | 99.9% |
| | of bacteria | | | | |

Table 5 shows the results of comparing the antibacterial effects of the petroleum-based polyol-based polyurethane foam (Comparative Example 1) in the related art, the biopolyol-based polyurethane foam (Example 1) manufactured from castor oil according to the present invention, and the biopolyol-based polyurethane foam (Example 4) manufactured from soybean oil according to the present invention. The results were obtained by injecting a solution containing 0.2 cc of Staphylococcus aureus ATCC 6538 and Klebsiella pneumoniae ATCC 4352 into a sample, allowing the resulting sample to stand at 37° C. for 18 hours, and then measuring the number of bacteria.

(Test facility: FITI Testing & Research Institute, Test specification: KS K 0693-2006 antibacterial degree)

As shown in Table 5, it was confirmed that the antibacterial effect of the polyurethane foam according to the present invention was significantly improved compared to that of the polyurethane foam in the related art, and it was determined that the improvement was caused by unreacted materials in the biopolyol. Further, physical properties of the foam were maintained even though unreacted materials were present in the biopolyol, and the antibacterial function was strengthened by the unreacted materials.

TABLE 6

| | Comparative | Comparative | Comparative | | | | |
|---|---|---|---|---|---|---|---|
| | Example 1 | Example 2 | Example 3 | Example 1 | Example 2 | Example 3 | Example 4 |
| Vibration | 6.4 | 6.8 | 7.1 | 3.0 | 3.2 | 3.5 | 3.8 |
| transmissivity | | | | | | | |

The vibration transmissivity is a value that was obtained by dividing all the vibration transmitted to a seat during driving by the vibration felt by a driver. A lower value indicates that vibration was greatly absorbed in the seat and, thus, dynamic comfort was improved.

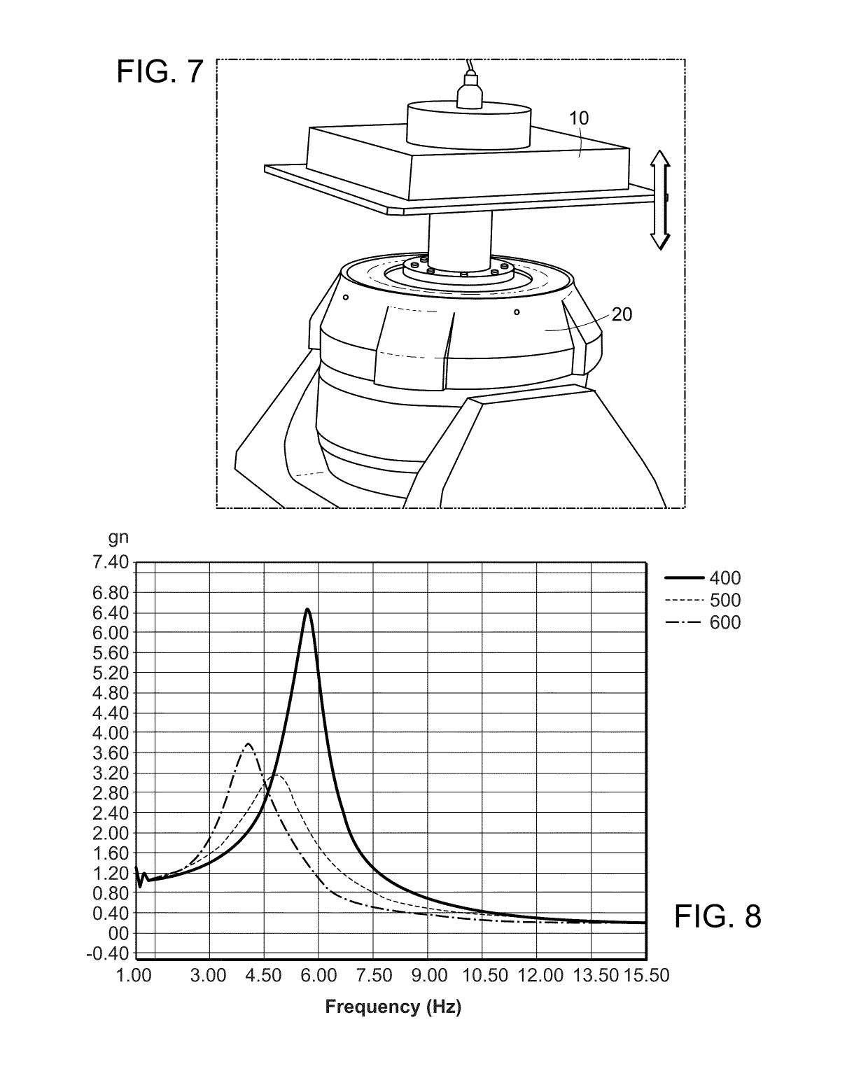

Table 6 shows the result of comparing vibration transmissivity of the petroleum-based polyol-based polyurethane foam in the related art and polyurethane foam according to the present invention. As illustrated in FIG. 7, the vibration transmissivity was measured by artificially transmitting vibration to the urethane foam through a vibration transmission measurement device. The results of Comparative Example 1 and Examples 1 and 4 are representatively shown through the graph in FIG. 8.

As described above, it was confirmed that the vibration transmissivity of the polyurethane foam according to the present invention was significantly reduced compared to the vibration transmissivity the petroleum-based polyol-based polyurethane foam in the related art, meaning that the polyurethane foam according to the present invention has excellent vibration absorption capacity and exhibits excellent comfort when applied to an automobile seat and the like.

As described above, the present invention has been described in relation to specific embodiments of the present invention, but the embodiments are only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A multi-functional bio polyurethane foam comprising:
a reaction product of a resin premix and a pre-polymer,
wherein the resin premix comprises from about 5% by weight to about 30% by weight of a biopolyol, based on total weight of the resin premix.

2. The multi-functional bio polyurethane foam of claim 1, wherein the pre-polymer is a pre-polymerization reaction product of isocyanate and the biopolyol.

3. The multi-functional bio polyurethane foam of claim 2, wherein the pre-polymer is present in an amount from about 30 parts by weight to about 70 parts by weight based on 100 parts by weight of the resin premix.

4. The multi-functional bio polyurethane foam of claim 2, wherein the biopolyol is prepared from castor oil or soybean oil.

5. The multi-functional bio polyurethane foam of claim 2, wherein the isocyanate comprises from about 10% by weight to about 70% by weight of monomeric methylene diphenyl diisocyanate (MMDI), from about 10% by weight to about 70% by weight of carbodiimide modified methylene diphenyl diisocyanate, from about 10% by weight to about 90% by weight of polymeric methylene diphenyl diisocyanate (PMDI), and from about 5% by weight to about 80% by weight of toluene diisocyanate (TDI) based on the total weight of the isocyanate.

6. The multi-functional bio polyurethane foam of claim 2, wherein % by weight of the biopolyol included in the resin premix based on the weight of the resin premix is the same as or about the same as % by weight of the biopolyol which is in the pre-polymerization reaction with the isocyanate based on the weight of the pre-polymer.

7. The multi-functional bio polyurethane foam of claim 1, wherein the resin premix further comprises from about 5% by weight to about 40% by weight of a base polyol, from about 15% by weight to about 55% by weight of a high molecular weight polyol, and from about 3% by weight to about 40% by weight of a polymer polyol based on the weight of the resin premix.

8. The multi-functional bio polyurethane foam of claim 4, wherein the biopolyol has a molecular weight (MW) from about 2,500 to about 3,500, the base polyol has a molecular weight (MW) from about 5,000 to about 6,000, and the high molecular weight polyol has a molecular weight (MW) from about 6,500 to about 7,500.

9. The multi-functional bio polyurethane foam of claim 7, wherein the base polyol and the high molecular weight polyol are selected from a polyether polyol, a polyester polyol, or a combination thereof.

10. The multi-functional bio polyurethane foam of claim 7, wherein the resin premix further comprises from about 0.1% by weight to about 1% by weight of a chain extender, more than 0 and less than about 5% by weight of a cross-linker, and from about 0.1% by weight to about 3% by weight of a silicone surfactant based on the weight of the resin premix.

11. The multi-functional bio polyurethane foam of claim 10, wherein the silicone surfactant comprises a first silicone surfactant and a second silicone surfactant, the second silicone surfactant being relatively more active than the first silicone surfactant.

12. The multi-functional bio polyurethane foam of claim 10, wherein the resin premix further comprises from about 1% by weight to about 5% by weight of a foaming agent, from about 0.1% by weight to about 3% by weight of a gelling catalyst, and from about 0.1% by weight to about 3% by weight of a blowing catalyst based on the weight of the resin premix.

13. An automobile seat manufactured of the multi-functional bio polyurethane of claim 1.

14. A method for manufacturing a multi-functional bio polyurethane foam, the method comprising:
forming a pre-polymer by pre-polymerizing a biopolyol with isocyanate; and
reacting the pre-polymer with a resin premix, the resin premix comprising from about 5% by weight to about 30% by weight of the biopolyol based on total weigh to the resin premix, thereby manufacturing the multi-functional bio polyurethane foam.

15. The method of claim 14, wherein the isocyanate comprises from about 10% by weight to about 70% by weight of monomeric methylene diphenyl diisocyanate (MMDI), from about 10% by weight to about 70% by weight of carbodiimide modified methylene diphenyl diisocyanate, from about 10% by weight to about 90% by weight of polymeric methylene diphenyl diisocyanate (PMDI), and from about 5% by weight to about 80% by weight of toluene diisocyanate (TDI) based on the total weight of the isocyanate.

16. The method of claim 14, wherein % by weight of the biopolyol included in the resin premix based on the weight of the resin premix is the same as or about the same % by weight of the biopolyol which is used in the step of forming the pre-polymer.
